(19) United States
(12) Patent Application Publication
(10) Pub. No.: US 2017/0067442 A1
(43) Pub. Date: Mar. 9, 2017

(54) APPARATUSES AND METHODS FOR BALANCING A WIND TURBINE ASSEMBLY

(71) Applicant: Noel R. Potter, Bountiful, UT (US)

(72) Inventor: Noel R. Potter, Bountiful, UT (US)

(21) Appl. No.: 14/848,579

(22) Filed: Sep. 9, 2015

(51) Int. Cl. F03D 7/06; F03D 13/10; F03D 3/00

(52) U.S. Cl. CPC F03D 7/06; F03D 3/005; F03D 13/10; F05B 2220/30; F05B 2230/60; F05B 2260/966

(57) ABSTRACT

A computer-implemented method for a wind turbine balancing apparatus of a wind turbine assembly is described. In one embodiment, a turbine shaft is configured to transmit mechanical power. A support structure is coupled to the turbine shaft. The support structure includes one or more support arms. A balancing channel is coupled to at least a portion of the support structure. The balancing channel includes a hollow chamber. A plurality of freely moving objects are placed within the hollow chamber of the balancing channel.

### TECHNICAL FIELD

The present disclosure relates generally to a wind turbine balancing tube, and more particularly, to apparatuses and methods for balancing a wind turbine assembly.

### BACKGROUND

A wind turbine assembly may include a turbine shaft configured to transmit mechanical power generated by the wind turbine assembly into electrical power. A support structure may connect to one or more vane shafts. Each vane shaft may include one or more airfoils. Each airfoil may be configured to spin freely on a vane shaft. Wind incident on an airfoil may cause the vane shaft to exert a force on the support structure, which force may be transferred to the turbine shaft, causing the turbine shaft to spin. The mechanical power of the turbine shaft spinning may be converted into electrical power via a generator/alternator assembly that is part of the wind turbine assembly.

In some cases, the force of the wind on the one or more airfoils may cause the turbine shaft to spin at certain relatively high speeds. At these certain relatively high speeds, the wind turbine assembly may experience adverse effects from an imbalance within the wind turbine assembly that may result in structural vibrations, resonance, speed wobbles, oscillations, vortex shedding, dynamic aeroelasticity, etc. A sustained and/or increasing amplitude of oscillation among the pieces of the wind turbine assembly may result in destruction of the wind turbine assembly. As a result, benefits may be realized by an apparatus and method for balancing a wind turbine assembly.

### SUMMARY

According to at least one embodiment, wind turbine balancing apparatus of a wind turbine assembly is described. In one embodiment, a turbine shaft may be configured to transmit mechanical power. A support structure may be coupled to the turbine shaft. The support structure may include one or more support arms, A balancing channel may be coupled to at least a portion of the support structure. The balancing channel may include a hollow chamber. A plurality of freely moving objects may be placed within the hollow chamber of the balancing channel.

In one embodiment, at least one of the plurality of freely moving objects may include a spherical object. In some embodiments, at least a portion of the balance channel may connect to the support structure toward a top portion of the wind turbine. Additionally, or alternatively, at least a portion of the balance channel may connect to the support structure toward a bottom portion of the wind turbine. In some cases, at least a portion of a cross section of the balancing channel comprises a circular portion. Additionally, or alternatively, at least a portion of a cross section of the balancing channel comprises an oval portion. In some embodiments, at least a portion of a cross section of the balancing channel comprises a top portion, a bottom portion, an inner wall portion toward the turbine shaft, and an outer wall portion toward the peripheral portion of the support structure.

In one embodiment, the support structure may include one or more support arms radiating outward away from the turbine shaft. The balancing channel may connect to at least one of the one or more of the plurality of support arms. The wind turbine assembly may include a vane shaft connected to at least one of the one or more support arms. The vane shaft may support one or more airfoils, The vane shaft may allow the airfoil to rotate freely about the vane shaft. In some embodiments, the balancing channel may connect to the vane shaft.

A method for balancing a wind turbine assembly is also described. In one embodiment, a turbine shaft to transmit mechanical power may be provided as part of the wind turbine assembly. A balancing channel may be provided that is coupled to a support structure of the wind turbine assembly. The balancing channel may include a hollow chamber. The support structure may be coupled to the turbine shaft. A plurality of freely moving objects may be placed within the hollow chamber of the balancing channel.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure;

FIG. 1 depicts an exemplary schematic diagram of a wind turbine assembly in which the present apparatuses and methods may be implemented;

FIG. 2 depicts another exemplary schematic diagram of a wind turbine assembly;

FIG. 3 depicts another exemplary schematic diagram of a wind turbine assembly;

FIG. 4 depicts a cross section of an oval balancing channel;

FIG. 5 depicts a cross section of a rectangular balancing channel; and

FIG. 6 is a flow diagram illustrating one embodiment of a method for balancing a wind turbine assembly.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The apparatuses and methods described herein relate to balancing a wind turbine assembly. More specifically, the apparatuses and methods described herein relate to providing a balancing channel on a wind turbine assembly to provide damping forces on the structure of the wind turbine assembly in order to dampen oscillations and/or vibrations in the operation of the wind turbine assembly.

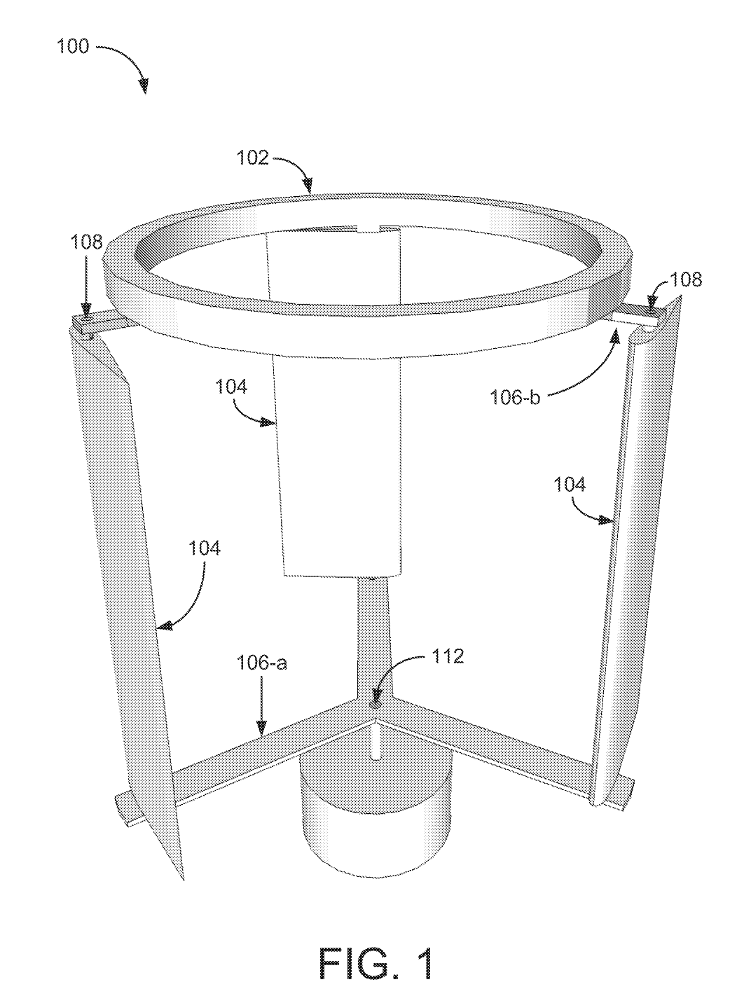

FIG. 1 depicts an exemplary schematic diagram of a wind turbine assembly 100 in which the present apparatuses and methods may be implemented.

As depicted, the wind turbine assembly 100 may include a balancing channel 102, one or more airfoils 104, one or more portions of support structure 106-a and/or 106-b, one or more vane shafts 108, and a turbine shall 112.

In one embodiment, the balancing channel 102 may be configured to provide damping forces on at least a portion of the depicted structure of the wind turbine assembly 100 in order to dampen oscillations and/or vibrations in the operation of the wind turbine assembly 100. In some embodiments, at least a portion of the balancing channel 102 may connect to one or more vane shafts 108. Additionally, or alternatively, at least a portion of the balance channel 102 may connect to the support structure 106-a and/or 106-b. In some cases, the balance channel may connect to the support structure 106-b toward a top portion of the wind turbine assembly 100. In some embodiments, at least a portion of the balance channel 102 may connect to the support structure 106-a toward a bottom portion of the wind turbine assembly 100.

As depicted, a balancing channel 102 may be sized to fit within the circumference of the vane shafts 108 when the wind turbine assembly 100 is spinning. Additionally, or alternatively, a balancing channel 102 may be sized to fit beyond the circumference of the vane shafts 108 when the wind turbine assembly 100 is spinning, extending outward from the center of the wind turbine assembly 100 beyond the distance from the vertical center of the wind turbine assembly 100 to the vane shafts 108, the vertical center of the wind turbine assembly 100 being in relation to the position of the turbine shaft 112 corresponding to the vertical center of the balancing channel 102.

In one embodiment, the turbine shaft 112 may connect to a bottom portion of the support structure 106-a. In some cases, the turbine shaft 112 may connect to a top and/or bottom portion of the support structure 106-a and/or 106-b. In some embodiments, the turbine shaft 112 may be configured to transmit mechanical power. The mechanical power may be transmitted by the turbine shaft 112 to a generator; alternator configured to convert the transmitted mechanical power into electrical power.

In one embodiment, the support structure 106 may include a portion located towards the top portion 106-b of the wind turbine assembly 100 and/or may include a portion 106-a located towards the bottom portion of the wind turbine assembly 100. As depicted, at least a portion of the top portion of the support structure 106-b may be connected to the balancing channel 102. In some cases, the bottom portion of the support structure 106-a may be coupled to the turbine shall 112.

In one embodiment, the balancing channel 102 may include a hollow chamber. In one embodiment, a plurality of freely moving objects may be situated within the hollow chamber of the balancing channel. In some cases, at least one of the plurality of freely moving objects may include one or more spherical objects such as beads.

In one embodiment, the support structure 106-a and/or 106-b may include a plurality of support arms radiating outward away from the turbine shall 112 to one or more vane shafts 108. In some cases, the balancing channel 102 may connect to one or more of the plurality of support arms. In some embodiments, each vane shall 108 may be connected to at least one of the plurality of support arms of the support structure 106-a and/or 106-h. Each vane shaft 108 may support one or more airfoils 104 In some embodiments, a vane shaft 108 may allow an airfoil 104 to rotate freely about the vane shaft 108.

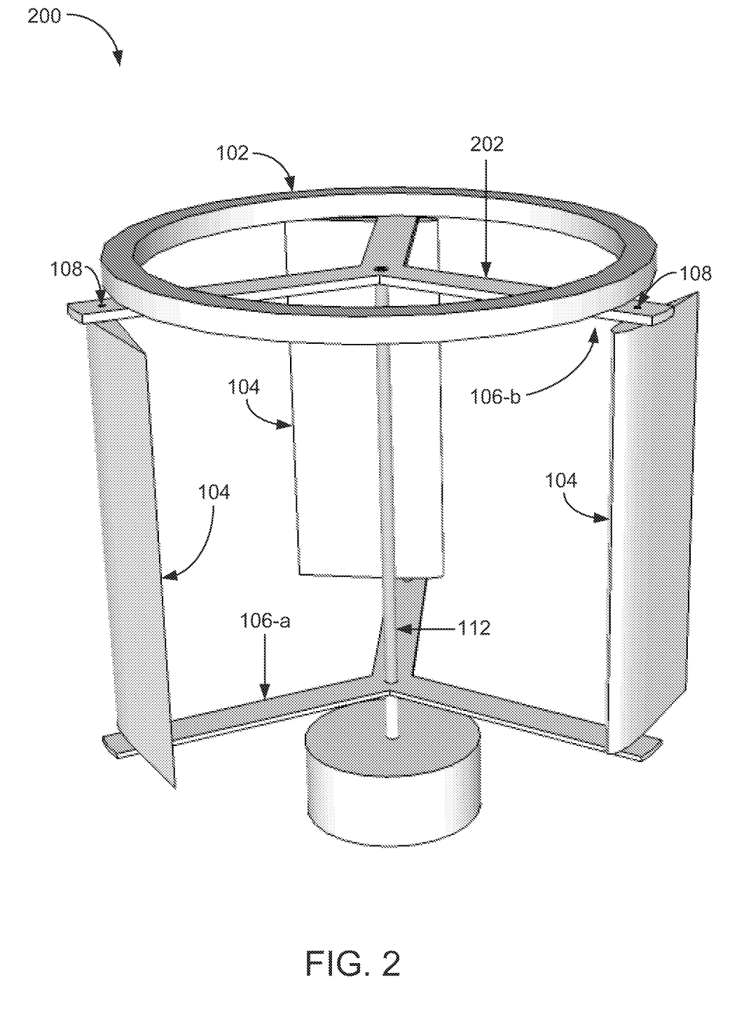

FIG. 2 depicts another exemplary schematic diagram of a wind turbine assembly 200 in which the present apparatuses and methods may be implemented. The wind turbine assembly 200 may be one example of the wind turbine assembly depicted in FIG. 1. As depicted, the turbine shaft 112 of the wind turbine assembly 200 may extend from a bottom portion of the wind turbine assembly 200 to an upper portion of the wind turbine assembly 200. In some embodiments, as depicted, the upper portion 106-b and the bottom portion 106-a of the support structure 106 may connect to the turbine shaft 112 via a plurality of support arms extending from the vane shafts 108 to the turbine shaft 112 located at the center of the wind turbine assembly 200.

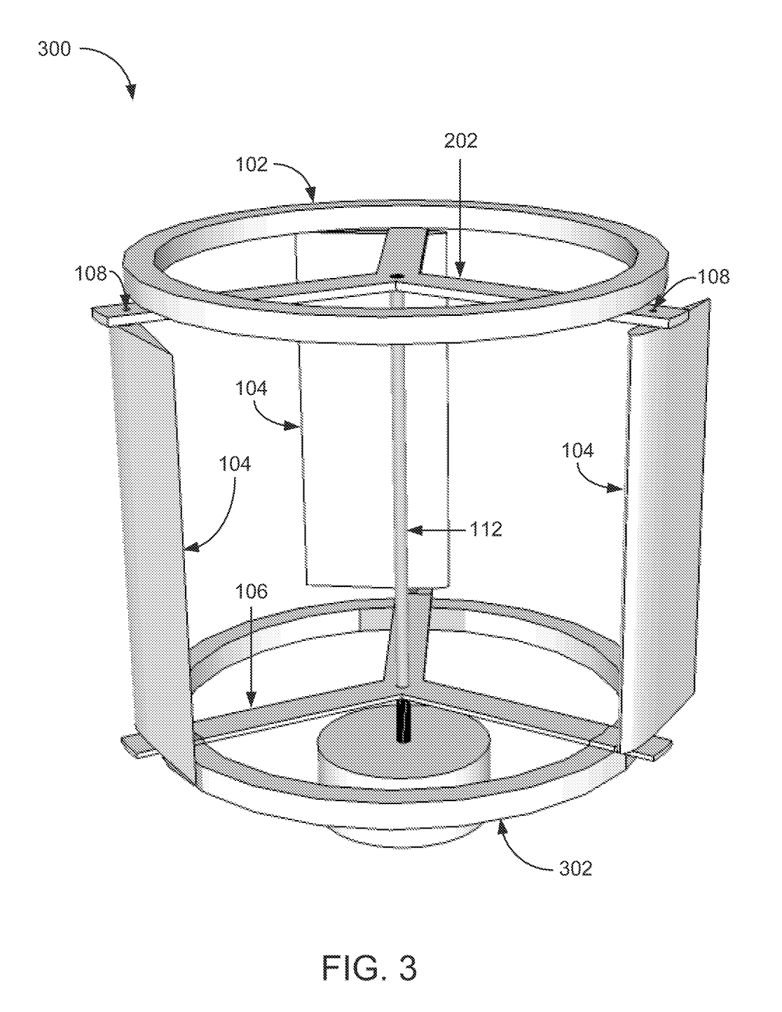

FIG. 3 depicts another exemplary schematic diagram of a wind turbine assembly 300 in which the present apparatuses and methods may be implemented. The wind turbine assembly 300 may be one example of the wind turbine assembly depicted in FIGS. 1 and/or 2. In some embodiments, the wind turbine assembly 300 may include an upper balancing channel 102 and a lower balancing channel 102.

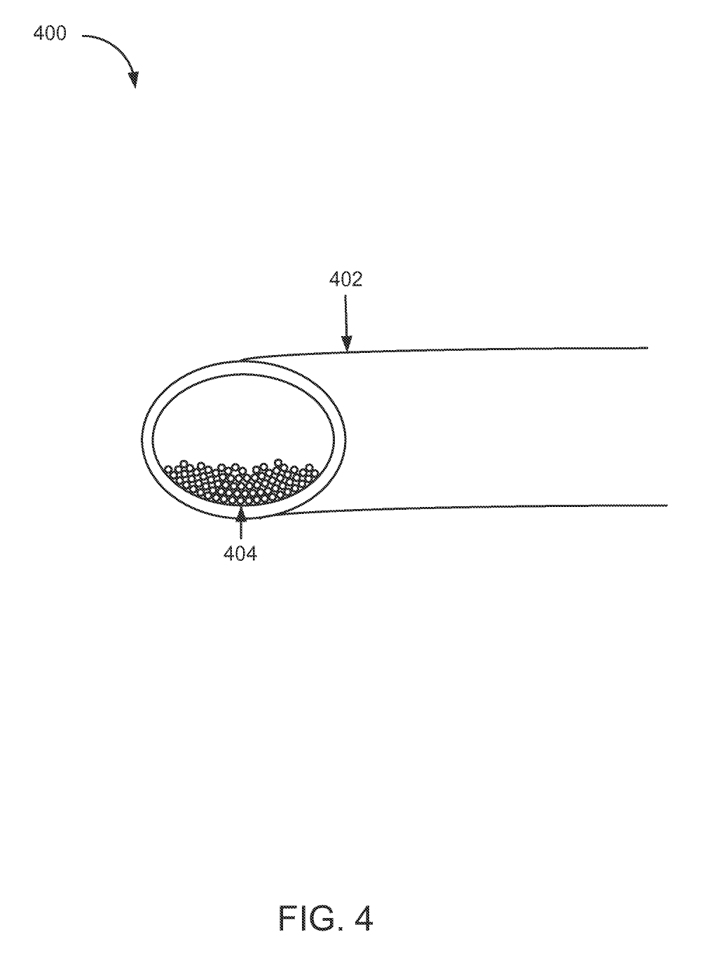

FIG. 4 depicts a cross section 400 of an oval balancing channel 402. In some embodiments, the cross section 400 may include the oval balancing channel 402 and a plurality of freely moving objects 404. The freely moving objects may include one or more spherical objects (e.g., low-friction beads, etc.). As depicted, in some embodiments, at least a portion of the cross section 400 of the balancing channel 402 may include a circular portion. At least a portion of a cross section 400 of the balancing channel 402 may include an oval portion.

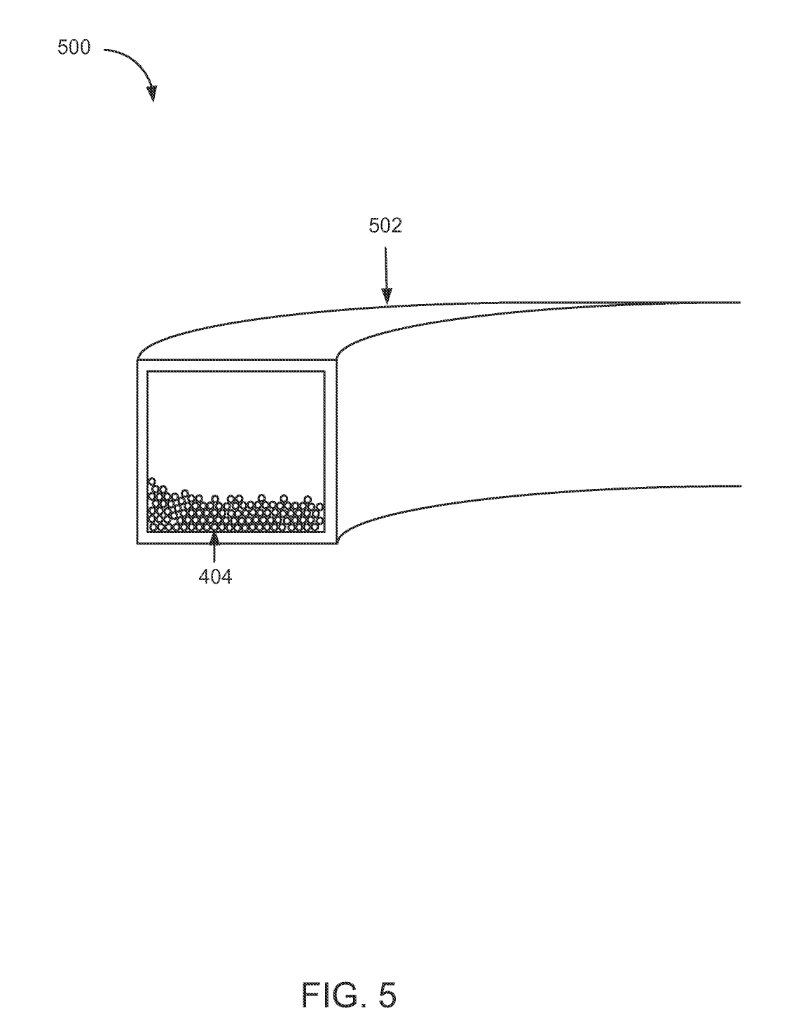

FIG. 5 depicts a cross section 500 of a rectangular balancing channel 502. In some embodiments, the rectangular balancing channel 502 may include a plurality of freely moving objects 404. The freely moving objects may include one or more spherical objects (e.g., low-friction beads, etc.). In some embodiments, at least a portion of a cross section 500 of the balancing channel 502 may include a top portion, a bottom portion, an inner wall portion located toward a turbine shaft located toward a vertical center of the wind turbine assembly, and an outer wall portion located toward a peripheral portion of the wind turbine assembly in relation to a vertical center of the wind turbine assembly.

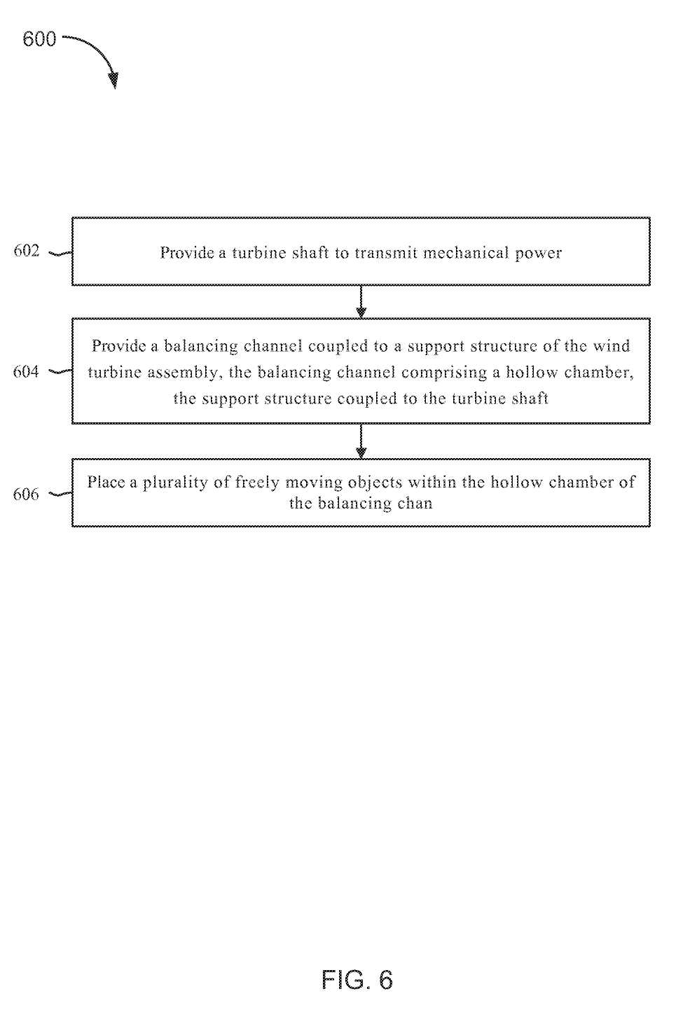

FIG. 6 is a flow diagram illustrating one embodiment of a method 600 for balancing a wind turbine assembly. In some configurations, the method 600 may be implemented by the balancing channel illustrated in FIGS. 4 and/or 5.

At block 602, a turbine shaft to transmit mechanical power may be provided as part of the wind turbine assembly. At block 604, a balancing channel may be provided that is coupled to a support structure of the wind turbine assembly. The balancing channel may include a hollow chamber. The support structure may be coupled to the turbine shaft. At block 606, a plurality of freely moving objects may be placed within the hollow chamber of the balancing channel.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, assembly, structural (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present apparatuses and methods and their practical applications, to thereby enable others skilled in the art to best utilize the present apparatuses and methods and various embodiments with various modifications as may be suited to the particular use contemplated.

Unless otherwise noted, the terms “a” or “an,” as used in the specification and claims, are to be construed as meaning “at least one of.” in addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A wind turbine balancing apparatus of a wind turbine assembly, the wind turbine assembly comprising:
a turbine shaft to transmit mechanical power;
a support structure coupled to the turbine shaft;
a balancing channel coupled to the support structure, the balancing channel comprising a hollow chamber;
a plurality of freely moving objects being placed within the hollow chamber of the balancing channel.

2. The wind turbine balancing apparatus of claim l , wherein at least one of the plurality of freely moving objects comprises a spherical object.

3. The wind turbine balancing apparatus of claim 1, wherein at least a portion of the balance channel connects to the support structure toward a top portion of the wind turbine.

4. The wind turbine balancing apparatus of claim 1, wherein at least a portion of the balance channel connects to the support structure toward a bottom portion of the wind turbine.

5. The wind turbine balancing apparatus of claim 1, wherein at least a portion of a cross section of the balancing channel comprises a circular portion.

6. The wind turbine balancing apparatus of claim 1, wherein at least a portion of a cross section of the balancing channel comprises an oval portion.

7. The wind turbine balancing apparatus of claim 1, wherein at least portion of a cross section of the balancing channel comprises a top portion, a bottom portion, an inner wall portion toward the turbine shaft, and an outer wall portion toward the peripheral portion of the support structure.

8. The wind turbine balancing apparatus of claim 1, the support structure further comprising:
a plurality of support arms radiating outward a =ay from the turbine shaft, wherein the balancing channel connects to one or more of the plurality of support arms.

9. The wind turbine balancing apparatus of claim 8, further comprising:
a vane shaft coupled to at least one of the plurality of support arms, the vane shaft to support an airfoil, the vane shaft allowing the airfoil to rotate freely about the vane shaft.

10. The wind turbine balancing apparatus of claim 9, wherein the balancing channel connects to the vane shaft.

11. A method for balancing a wind turbine assembly, the method comprising:
providing a turbine shaft to transmit mechanical power;
providing a balancing channel coupled to a support structure of he wind turbine assembly, the balancing channel comprising a hollow chamber, the support structure coupled to the turbine shaft;
placing a plurality of freely moving objects within the hollow chamber of the balancing channel.
